(19) United States
(12) Patent Application Publication
(10) Pub. No.: US 2013/0311395 A1
(43) Pub. Date: Nov. 21, 2013

(54) METHOD AND SYSTEM FOR PROVIDING PERSONALIZED REVIEWS TO A USER

(71) Applicants: Amit BOHRA, Bangalore (IN); Satyajit RAI, Bangalore (IN)

(72) Inventors: Amit BOHRA, Bangalore (IN); Satyajit RAI, Bangalore (IN)

(73) Assignee: YAHOO! INC., Sunnyvale, CA (US)

(21) Appl. No.: 13/473,607

(22) Filed: May 17, 2012

(51) Int. Cl. G06Q 30/00

(52) U.S. Cl. 705/347

(57) ABSTRACT

A method and system for providing personalized reviews to a user. The method includes identifying multiple reviews, provided by multiple reviewers, on an entity; generating multiple profiles corresponding to the multiple reviewers; classifying the reviewers into one or more groups, each of the one or more groups includes a corresponding list of similar reviewers; mapping the user to a group, of the one or more groups, corresponding to the entity; and displaying one or more reviews, provided by the list of similar reviewers, along with comments associated with the one or more reviews. The system includes an electronic device, a communication interface, a memory and a processor to identify multiple reviews, to generate multiple profiles, to classify the reviewers into one or more groups, to map the user to a group and to display one or more reviews along with comments associated with the one or more reviews.

### TECHNICAL FIELD

Embodiments of the disclosure relate to the field of providing reviews on various products and services present online and more specifically to providing personalized reviews to a user.

### BACKGROUND

Providing reviews, by reviewers, on an entity is useful as the reviews can be used as feedback for a user viewing the reviews. The entity, in one example, can include a product, a service and an entertainment class. In another example, the reviews can be provided upon purchasing or experiencing the entity, by the reviewers. The reviews enable the user to evaluate the entity for making various decisions associated with the entity. The reviews, in one example, can define a quality of the entity. In another example, the reviews can make suggestions to purchase the entity. The reviews can also be rated by one or more users logging into the website. Further, the users can also provide comments on the reviews. However, in recent times, number of the reviewers providing the reviews, on the entity, are increasing at a larger pace. Hence, it is time consuming for the user to read each review for evaluating the entity.

In Conventional techniques the reviews are filtered based on one or more standards to generate filtered reviews. The standards can include filtering the reviews based on a validity period associated with each of the reviews or filtering the reviews possessing prominent number of votes and ranks that are provided by the users logging into the website. The filtered reviews along with the comments are further displayed for the user to view. However, the filtered reviews are not personalized to the user. Consequently, the user is unable to evaluate the entity based on the filtered reviews, thereby the filtered reviews may not serve a purpose of the user.

In the light of the foregoing discussion there is a need for a method and a system for providing reviews that are personalized to the user.

### SUMMARY

The above-mentioned needs are met by a method, a computer program product and a system for providing personalized reviews to a user.

An example of a method of providing personalized reviews to a user includes identifying a plurality of reviews, provided by a plurality of reviewers, on an entity. The method also includes generating a plurality of profiles corresponding to the reviewers. Each of the profiles includes data that defines a plurality of attributes associated with each of the reviewers. Further, the method includes classifying the reviewers into one or more groups. Each of the one or more groups comprises a corresponding list of similar reviewers corresponding to the entity. The list of similar reviewers possessing at least one of the attributes similar to each other. Furthermore, the method includes mapping the user to a group, of the one or more of groups, corresponding to the entity. The mapping is being performed based on a similarity level existing between the attributes associated with the list of similar reviewers included in the group and the attributes associated with the user. Moreover, the method includes displaying, to the user, one or more reviews, provided by the list of similar reviewers, along with comments associated with the one or more reviews.

An example of a computer program product stored on a non-transitory computer-readable medium that when executed by a processor, performs a method of providing personalized reviews to a user includes identifying a plurality of reviews, provided by a plurality of reviewers, on an entity. The computer program product also includes generating a plurality of profiles corresponding to the reviewers. Each of the profiles includes data that defines a plurality of attributes associated with each of the reviewers. Further, the computer program product includes classifying the reviewers into one or more groups corresponding to the entity. Each of the groups includes a corresponding list of similar reviewers. The list of similar reviewers possessing at least one of the attributes similar to each other. Furthermore, the computer program product includes mapping the user to a group, of the one or more of groups, corresponding to the entity. The mapping is being performed based on a similarity level existing between the attributes associated with the list of similar reviewers included in the group and the associated with the user. Moreover, the computer program product includes displaying, to the user, one or more reviews, provided by the list of similar reviewers, along with comments associated with the one or more reviews.

An example of a system for providing personalized reviews to a user includes an electronic device. The system also includes a communication interface in electronic communication with the electronic device. The system further includes a memory that stores instructions. Further, the system includes a processor responsive to the instructions to identify a plurality of reviews, provided by a plurality of reviewers, on an entity. The processor is also responsive to the instructions to generate a plurality of profiles corresponding to the reviewers. Each of the profiles includes data that defines a plurality of attributes associated with each of the reviewers. Further, the processor is responsive to the instructions to classify the reviewers into one or more groups. Each of the groups includes a corresponding list of similar reviewers corresponding to the entity. The list of similar reviewers possessing at least one of the attributes similar to each other. The processor is further responsive to the instructions to map the user to a group, of the one or more groups, corresponding to the entity. Mapping is being performed based on a similarity level existing between the attributes associated with the list of similar reviewers included in the group and the attributes associated with the user. Furthermore, the processor is responsive to the instructions to display, to the user, one or more reviews provided by the list of similar reviewers along with comments associated with the one or more reviews.

### BRIEF DESCRIPTION OF THE FIGURES

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of an environment, in accordance with which various embodiments can be implemented;

FIG. 2 is a block diagram of a server, in accordance with one embodiment;

FIG. 3 is a flow diagram illustrating a method of providing personalized reviews to a user, in accordance with one embodiment; and

FIGS. 4A-4B illustrate an exemplary view of providing personalized reviews to a user, in accordance with one embodiment.

### DETAILED DESCRIPTION OF THE EMBODIMENTS

The above-mentioned needs are met by a method, computer program product and system for providing personalized reviews to a user. The following detailed description is intended to provide example implementations to one of ordinary skill in the art, and is not intended to limit the invention to the explicit disclosure, as one or ordinary skill in the art will understand that variations can be substituted that are within the scope of the invention as described.

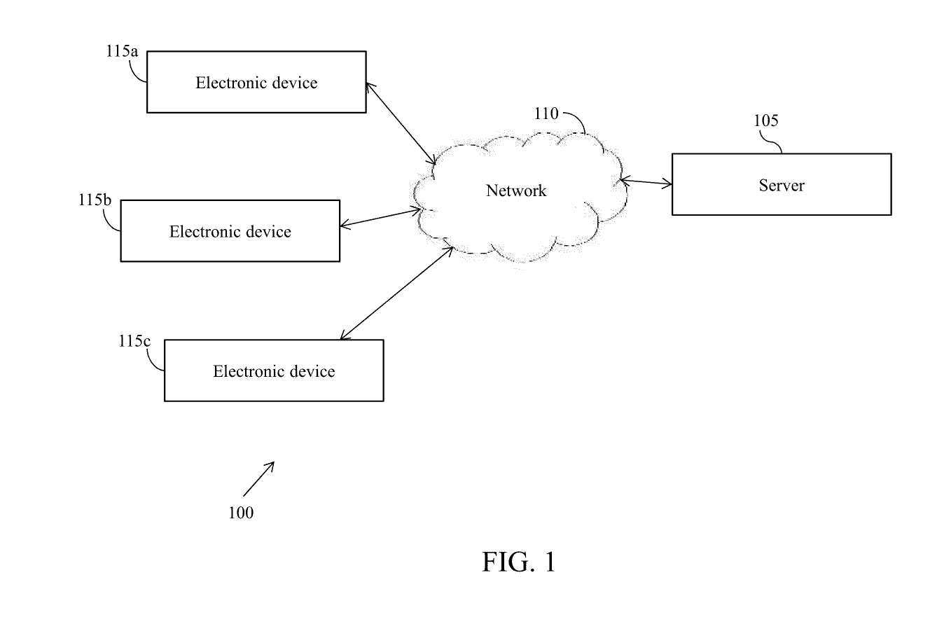

FIG. 1 is a block diagram of an environment 100, in accordance with which various embodiments can be implemented.

The environment 100 includes a server 105. The environment 100 further includes one or more electronic devices, for example an electronic device 115a, an electronic device 115b, and an electronic device 115c. The electronic devices can communicate with the server 105 through a network 110. Examples of the electronic devices include, but are not limited to, computers, mobile devices, laptops, palmtops, hand held devices, telecommunication devices and personal digital assistants (PDAs).

The server 105 is in electronic communication with the electronic devices through the network 110. The server 105 can be located remotely with respect to the electronic devices. Examples of the network 110 include, but are not limited to, a Local Area Network (LAN), a Wireless Local Area Network (WLAN), a Wide Area Network (WAN), internet, a Small Area Network (SAN) and a telephone network.

In some embodiments, an electronic device, for example the electronic device 115a, can perform functions of the server 105.

A user of an electronic device, for example, the electronic device 115a logs into a website and further wishes to view reviews provided, by multiple reviewers, on an entity. The reviews can also be viewed via a mobile application or an application programming interface (API). The user can also view one or more comments associated with the reviews. Examples of the entity include, but are not limited to, a product, a service and an entertainment class, for example, music, videos and movies. The user can select the entity prior to viewing the reviews and the comments associated with the reviews provided on the entity. The reviews and the comments enable the user to evaluate the entity and further make one or more decisions, for example, a decision to purchase the entity.

The reviews provided to the users are obtained from the reviewers possessing attributes similar to the attributes of the user. Examples of the attributes include, but are not limited to, interest, location, age, gender, behavior, purchase habits, purchase history, historical data and the like. Each reviewer is associated with a profile. The profile maintains data that includes the attributes, of the reviewer, corresponding to each entity. The server 105 is enabled to maintain the profile associated with each reviewer.

In some embodiments, the reviewers are classified into multiple groups. Each group includes a corresponding list of similar reviewers. Each reviewer present in the corresponding list of similar reviewers possesses the attributes that are similar to each other. Classification is performed based on the entity. Therefore, a group of reviewers possessing similar attributes for the entity is classified into one group. Similarly, the multiple groups formed include reviewers possessing similar attributes, corresponding to various entities. Further, a single reviewer can be classified under one or more groups based on the entity. The server 105 is configured to classify the reviewers into the groups. The server is further configured to store the groups in a database. The database, maintained by the server 105, includes multiple groups with the corresponding list of similar reviewers included in each group.

In some embodiments, the user is mapped to a group upon wishing to view the reviews on the entity. Mapping is performed based on similarity of the attributes associated with the corresponding list of similar reviewers included in the group and the attributes associated with the user. Similarly, the user can be mapped to different groups for different entities. Further, upon mapping, the reviews provided by the corresponding list of similar reviewers, included in the group, are provided to the user. In some embodiments, one or more comments associated with the reviews are also provided to the user. The reviews are regarded as personalized reviews, corresponding to the entity, since the reviews provided by the corresponding list of similar reviewers, included in the group, possess the attributes that are similar to the user. Hence, the personalized reviews are meaningful and further enable the user to make decisions, thereby meeting a purpose of the user.

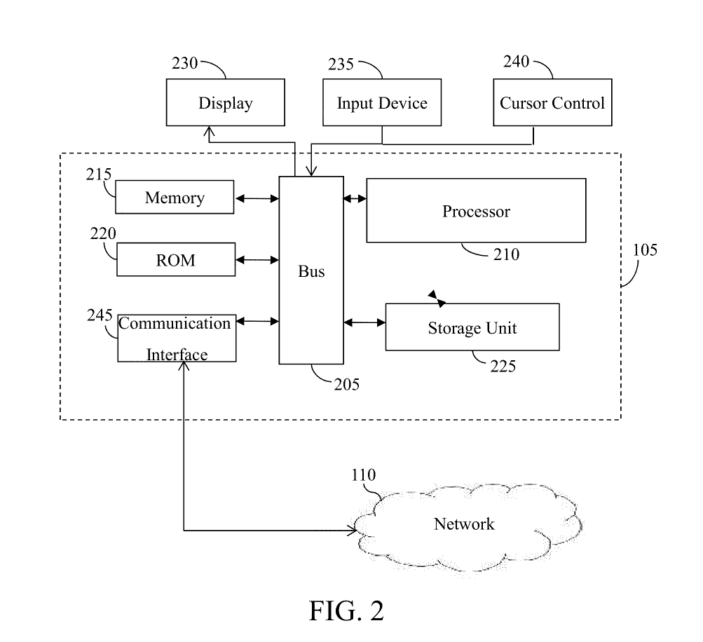

The server 105 including a plurality of elements configured to provide personalized reviews to the user is explained in detail in conjunction with FIG. 2.

FIG. 2 is a block diagram of a server 105, in accordance with one embodiment.

The server 105 includes a bus 205 or other communication mechanism for communicating information, and a processor 210 coupled with the bus 205 for processing information. The server 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The server 105 further includes a read only memory (ROM) 220 or other static storage device coupled to the bus 205 for storing static information and instructions for the processor 210. A storage unit 225, for example a magnetic disk or optical disk, is provided and coupled to the bus 205 for storing information, for example various attributes of a user and various attributes associated with a plurality of reviewers.

The server 105 can be coupled via the bus 205 to a display 230, for example a cathode ray tube (CRT), for displaying a plurality of reviews provided by the reviewers. The input device 235, including alphanumeric and other keys, is coupled to the bus 205 for communicating information and command selections to the processor 210. Another type of user input device is the cursor control 240, for example a mouse, a trackball, or cursor direction keys for communicating direction information and command selections to the processor 210 and for controlling cursor movement on the display 230.

Various embodiments are related to the use of the server 105 for implementing the techniques described herein. In some embodiments, the techniques are performed by the server 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the server 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, optical or magnetic disks, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that include the bus 205. Transmission media can also take the form of acoustic or light waves, such as those generated during radio-wave and infra-red data communications. Examples of machine-readable media may include, but are not limited to, a carrier wave as described hereinafter or any other media from which the server 105 can read. For example, the instructions can initially be carried on a magnetic disk of a remote computer. The remote computer can load the instructions into its dynamic memory and send the instructions over a telephone line using a modem. A modem local to the server 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The server 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. In any such implementation, the communication interface 245 sends and receives electrical, electromagnetic or optical signals that carry digital data streams representing various types of information.

The processor 210 in the server 105 is configured to identify the reviews, provided by the reviewers, on an entity. The processor 210 in the server 105 is also configured to generate a profile corresponding to each of the reviewers. The profile generated by the processor 210 includes the data that defines various attributes associated with each of the reviewers. Further, the processor 210 in the server 105 is operable to classify the reviewers into one or more groups. Each of the groups includes a corresponding list of similar reviewers corresponding to the entity. The reviewers included in the list of similar reviewers have the attributes similar to each other. The processor 210 determines the list of similar reviewers by assigning a weight factor to each of the attributes associated with the multiple reviewers. The processor 210 further stores the groups, including the list of similar reviewers, in a database.

The processor 210 in the server 105 is further operable to map the user to a group, of the groups, corresponding to the entity. The processor 210 maps the user, to the group, based on a similarity level existing between the attributes associated with the list of similar reviewers included in the group and the attributes associated with the user. The processor 210 generates a user profile for maintaining the attributes associated with the user. Furthermore, the processor 210 presents, to the user, one or more reviews provided by the list of similar reviewers included in the group. In some embodiments, one or more comments associated with the reviews are also displayed to the user. Moreover, the processor 210 in the server 105 is configured to arrange the reviews provided by the list of similar reviewers in a sequential order. The processor 210 arranges the reviews based on a degree of similarity between the attributes associated with each reviewer of the list of similar reviewers and the plurality of attributes associated with the user.

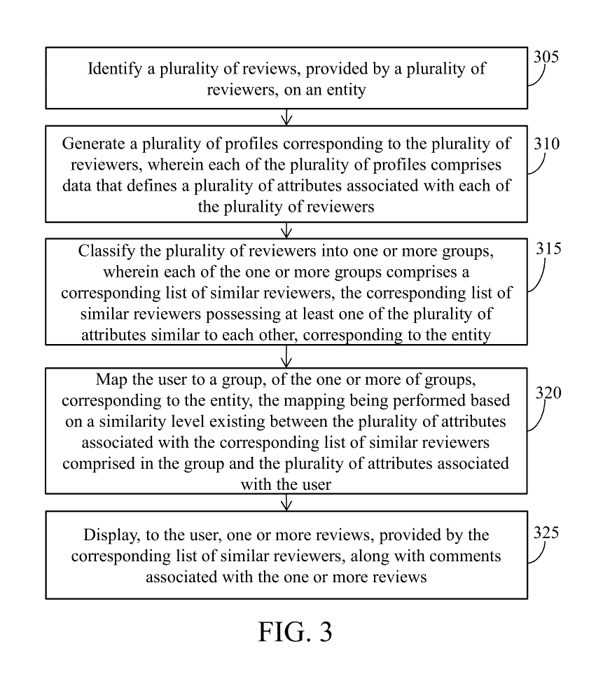

A method for providing personalized reviews to the user is explained in detail in conjunction with FIG. 3.

FIG. 3 is a flow diagram illustrating a method of providing personalized reviews to a user, in accordance with one embodiment. Examples of the personalized reviews include, but are not limited to, comments and user feedback.

At step 305, a plurality of reviews, on an entity, provided by a plurality of reviewers are identified. Examples of the entity include, but are not limited to, a product, a service and an entertainment class, for example, music, videos and movies. Examples of the services include, but are not limited to, hotels, flight bookings and reviews about human abilities. The reviews, on the entity, are displayed on a webpage. The reviews can also be viewed via a mobile application or an API. The reviews can be provided, by the reviewers, upon using or experiencing the entity. The reviews represent different opinions of the entity. The reviewers providing reviews on the entity can be identified when the user is offline. The reviews also enable the user to make one or more decisions, for example, a decision to purchase the entity. One or more algorithms are used for identifying the reviews provided by the reviewers for the entity.

At step 310, a plurality of profiles corresponding to the reviewers is generated. Each of the profiles includes data that defines various attributes associated with each of the reviewers. Examples of the attributes include, but are not limited to, interest, location, age, gender, behavior, preference, purchase habits, purchase history and historical data. The data is obtained from various online sources, for example, social networking sites, shopping websites, user registration profiles and third party services possessing the data that defines various attributes associated with each of the reviewers. The profile corresponding to each of the reviewers is generated to determine the reviewers similar to each other. The profiles corresponding to the reviewers can be generated when the user is offline.

In one example, the attributes of one reviewer can include an interest to purchase electronic gadgets, an interest in Chinese food and a preference for horror movies. Hence, the profile associated with the reviewer includes the data that indicates the interest to purchase electronic gadgets, the interest in Chinese food and the preference for horror movies. The data included in the profile is used to determine one or more reviewers with the attributes that are similar to the reviewer.

At step 315, the reviewers are classified into one or more groups. Each group comprises a corresponding list of similar reviewers. A similarity in the attributes associated with each of the reviewers is used to determine the list of similar reviewers. Further, each entity is associated with various aspects. The aspects associated with the entity can be obtained manually or dynamically. The list of similar reviewers is obtained for each aspect associated with the entity. Hence, each reviewer, present in the list of similar reviewers, is associated with the attributes that are similar to each other for each aspect associated with the entity. Classification of the reviewers into the groups can be performed when the user is offline.

The list of similar reviewers is grouped for each entity. The list of similar reviewers, included in each group, is calculated by assigning a weight factor to each attribute. The weight factor, to each attribute, is assigned based on the entity. Various algorithms, for example, clustering algorithms, artificial intelligence and data mining algorithms can be used for determining the similarity in the attributes. In some embodiments, a single reviewer can be included in multiple groups based on the entity. Further, the groups, including the list of similar reviewers, are stored in a database to enable mapping of the user to one of the groups. The database is updated at regular time intervals. Updating, in one example, includes addition of one or more reviewers to the groups corresponding to the entity.

At step 320, the user is mapped to a group. The group includes a list of similar reviewers for the entity. Mapping of the user to the group is based on the similarity between the attributes associated with each reviewer included in the group and the attributes associated with the user. A user profile is generated prior to mapping the user to the group. The user profile includes data that defines the attributes associated with the user. The attributes maintained by the user profile are obtained from the online sources. Similarly, the user can be mapped to various groups based on the entity selected by the user. The mapping of the user to the group can be performed when the user is not connected to internet. Further, the mapping of the user to the group can also be performed when the user is connected to the internet.

At step 325, one or more reviews are provided, to the user, for viewing. In some embodiments, one or more comments associated with the reviews are also provided to the user. The comments are provided by one or more users viewing the plurality of reviews. The reviews enable the user to approximately assess the entity since the attributes associated with each reviewer included in the group is similar to the attributes associated with the user. Hence, perceptiveness on the entity can be similar to the user and each reviewer included in the group, thereby providing the reviews that are meaningful.

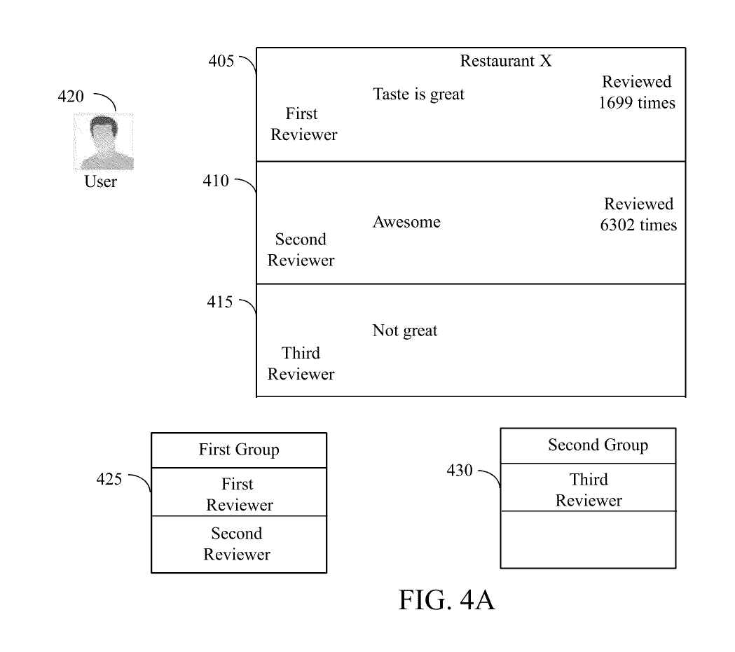

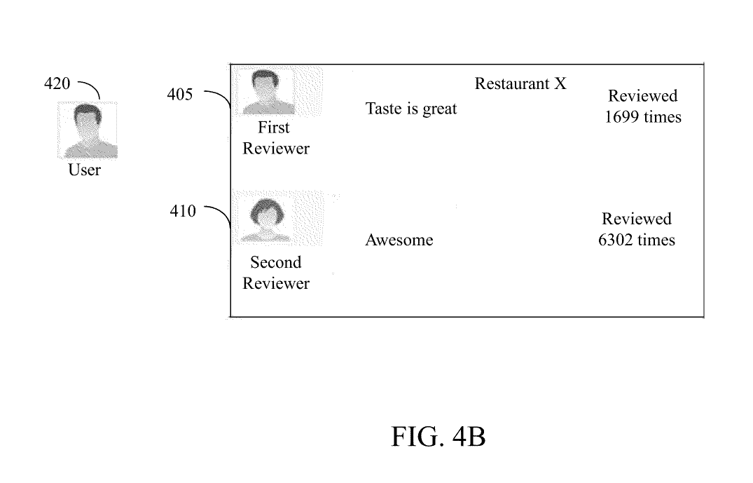

FIGS. 4A-4B illustrate an exemplary view of providing personalized reviews to a user, in accordance with one embodiment.

FIG. 4A includes a user 420, and multiple reviewers, for example, a first reviewer 405, a second reviewer 410 and a third reviewer 415. FIG. 4A also includes reviews provided, on a restaurant X, by the first reviewer 405, the second reviewer 410 and the third reviewer 415. The restaurant X serves Chinese food and Continental food. A profile associated with each reviewer is generated and includes various attributes of the reviewer. In one example, the profile associated with the first reviewer 405 indicates that the first reviewer 405 likes continental food. The profile associated with the second reviewer 410 indicates that the second reviewer 410 also likes the continental food. The profile associated with the third reviewer 415 indicates that the third reviewer 415 likes Chinese food. Further, the user 420 is associated with a user profile. The user profile indicates that the user 420 prefers continental food.

The reviewers are classified into multiple groups. As the first reviewer 405 and the second reviewer 410 likes continental food, the first reviewer 405 and the second reviewer 410 are considered to possess similar attributes. Hence, the first reviewer 405 and the second reviewer 410 are classified into a group, for example, a first group 425. As the third reviewer 415 likes Chinese food, the third reviewer 415 is classified into another group, for example, a second group 430.

Upon classifying the reviewers, the user 420 is mapped to the first group 425. The user 420 is mapped to the first group 425 since the first reviewer 405, the second reviewer 410 and the user 420 have an interest in continental food. Hence, the first reviewer 405, the second reviewer 410 and the user 420 are considered to have similar attributes corresponding to an eating habit.

Furthermore, upon mapping the user 420, the reviews provided by the first reviewer 405 and the second reviewer 410 are displayed to the user 420. The reviews displayed to the user 420 enable the user 420 to make one or more decisions, for example, decision to dine at the restaurant X. The reviews displayed to the user 420 are approximate due to similarity of the attributes associated with the first reviewer 405, the second reviewer 410 and the user 420. In some embodiments, the reviews provided by the first reviewer 405 and the second reviewer 410 are arranged in a sequential order prior to displaying the reviews to the user 420. The reviews are arranged based on a degree of similarity existing between the attributes associated with the first reviewer 405, second reviewer 410 and the user 420.

The method specified in the present disclosure enables a user to obtain personalized reviews and comments, on an entity, by displaying the reviews provided by the reviewers possessing attributes similar to the attributes of the user. By displaying the personalized reviews, the user is enabled to make useful decisions associated with the entity since the personalized reviews are appropriate. Further, the personalized reviews provided to the user improve user experience. Further, the personalized reviews that are filtered from a large number of reviews prevent the user from reading each review, thereby saving time. Furthermore, filtering the personalized reviews eliminates the problem of averaging out of the reviews, provided by various reviewers with diverse behaviors, which may be misleading.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method of providing personalized reviews to a user, the method comprising:
identifying a plurality of reviews, provided by a plurality of reviewers, on an entity;
generating a plurality of profiles corresponding to the plurality of reviewers, wherein each of the plurality of profiles comprises data that defines a plurality of attributes associated with each of the plurality of reviewers;
classifying the plurality of reviewers into one or more groups, wherein each of the one or more groups comprises a corresponding list of similar reviewers, the corresponding list of similar reviewers possessing at least one of the plurality of attributes similar to each other, corresponding to the entity;
mapping the user to a group, of the one or more of groups, corresponding to the entity, the mapping being performed based on a similarity level existing between the plurality of attributes associated with the corresponding list of similar reviewers comprised in the group and the plurality of attributes associated with the user; and
providing, to the user, one or more reviews, provided by the corresponding list of similar reviewers, along with comments associated with the one or more reviews.

2. The method as claimed in claim 1, wherein the entity comprises at least one of a product, a service and an entertainment class.

3. The method as claimed in claim 1 and further comprising:
generating a user profile, the user profile comprising the plurality of attributes associated with the user.

4. The method as claimed in claim 1, wherein the plurality of attributes associated with each of the plurality of reviewers is determined from a plurality of online sources.

5. The method as claimed in claim 1 and further comprising:
assigning a weight factor to each of the plurality of attributes, wherein the weight factor is used to determine the corresponding list of similar reviewers.

6. The method as claimed in claim 1 and further comprising:
storing the one or more groups comprising the corresponding list of similar reviewers in a database, the database being updated at regular time intervals.

7. The method as claimed in claim 1 and further comprising:
arranging the one or more reviews provided by the corresponding list of similar reviewers in a sequential order, wherein the sequential order is obtained based on a degree of similarity between the plurality of attributes associated with each of the corresponding list of similar reviewers and the plurality of attributes associated with the user.

8. The method as claimed in claim 1, wherein the comments associated with the one or more reviews are provided by one or more users viewing the plurality of reviews.

9. A computer program product stored on a non-transitory computer-readable medium that when executed by a processor, performs a method of providing personalized reviews to a user, the method comprising:
identifying a plurality of reviews, provided by a plurality of reviewers, on an entity;
generating a plurality of profiles corresponding to the plurality of reviewers, wherein each of the plurality of profiles comprises data that defines a plurality of attributes associated with each of the plurality of reviewers;
classifying the plurality of reviewers into one or more groups, wherein each of the one or more groups comprises a corresponding list of similar reviewers, the corresponding list of similar reviewers possessing at least one of the plurality of attributes similar to each other, corresponding to the entity;
mapping the user to a group, of the one or more groups, corresponding to the entity, the mapping being performed based on a similarity level existing between the plurality of attributes associated with the corresponding list of similar reviewers comprised in the group and the plurality of attributes associated with the user; and
providing, to the user, one or more reviews, provided by the corresponding list of similar reviewers, along with comments associated with the one or more reviews.

10. The computer program product as claimed in claim 9, wherein the entity comprises at least one of a product, a service and an entertainment class.

11. The computer program product as claimed in claim 9 and further comprising:
generating a user profile, the user profile comprising the plurality of attributes associated with the user.

12. The computer program product as claimed in claim 9, wherein the plurality of attributes associated with each of the plurality of reviewers is determined from a plurality of online sources.

13. The computer program product as claimed in claim 9 and further comprising:
assigning a weight factor to each of the plurality of attributes wherein the weight factor is used to determine the corresponding list of similar reviewers.

14. The computer program product as claimed in claim 9 and further comprising:
storing the one or more groups comprising the corresponding list of similar reviewers in a database, the database being updated at regular time intervals.

15. The computer program product as claimed in claim 9 and further comprising:
arranging the one or more reviews provided by the corresponding list of similar reviewers in a sequential order, wherein the sequential order is obtained based on a degree of similarity between the plurality of attributes associated with each of the corresponding list of similar reviewers and the plurality of attributes associated with the user.

16. The computer program product as claimed in claim 9, wherein the comments associated with the one or more reviews are provided by one or more users viewing the plurality of reviews.

17. A system for providing personalized reviews to a user, the system comprising:
an electronic device;
a communication interface in electronic communication with the electronic device;
a memory that stores instructions; and
a processor responsive to the instructions to
identify a plurality of reviews, provided by a plurality of reviewers, on an entity;
generate a plurality of profiles corresponding to the plurality of reviewers, wherein each of the plurality of profiles comprises data that defines a plurality of attributes associated with each of the plurality of reviewers;
classify the plurality of reviewers into one or more groups, wherein each of the one or more groups comprises a corresponding list of similar reviewers, the corresponding list of similar reviewers possessing at least one of the plurality of attributes similar to each other, corresponding to the entity;
map the user to a group, of the one or more groups, corresponding to the entity, mapping being performed based on a similarity level existing between the plurality of attributes associated with the corresponding list of similar reviewers comprised in the group and the plurality of attributes associated with the user; and
provide, to the user, one or more reviews provided by the corresponding list of similar reviewers along with comments associated with the one or more reviews.

18. The system as claimed in claim 17, wherein the processor is further configured to generate a user profile, the user profile comprising the plurality of attributes associated with the user.

19. The system as claimed in claim 17, wherein the processor is further configured to assign a weight factor to each of the plurality of attributes, wherein the weight factor is used to determine the corresponding list of similar reviewers.

20. The system as claimed in claim 17, wherein the processor is further configured to store the one or more groups comprising the corresponding list of similar reviewers in a database.

21. The system as claimed in claim 17, wherein the processor is further configured to arrange the one or more reviews provided by the corresponding list of similar reviewers in a sequential order, wherein the sequential order is obtained based on a degree of similarity between the plurality of attributes associated with each of the corresponding list of similar reviewers and the plurality of attributes associated with the user.
